(19) United States
(12) Patent Application Publication
(10) Pub. No.: US 2003/0124049 A1
(43) Pub. Date: Jul. 3, 2003

(54) Catalytic reactor apparatus and method for generating high purity water vapor

(76) Inventors: Sowmya Krishnan, Newark, CA (US); Mohamed Saleem, Fremont, CA (US); Matthew Milburn, Boulder Creek, CA (US)

Correspondence Address: LEARY & ASSOCIATES, 3900 NEWPARK MALL RD., THIRD FLOOR, SUITE 317, NEWARK, CA, 94560, US

(21) Appl. No.: 10/219,988

(22) Filed: Aug. 13, 2002

Related U.S. Application Data
(60) Provisional application No. 60/311,887, filed on Aug. 13, 2001.

(51) Int. Cl. C01B 5/00

(52) U.S. Cl. 423/580.1; 422/211

(57) ABSTRACT

A catalytic reactor apparatus produces high purity water vapor by reacting hydrogen and oxygen together within a catalytic reaction chamber. The reactants and an inert gas, such as argon gas or nitrogen, are supplied to the catalytic reaction chamber in a controlled fashion by a gas panel. The cylindrical catalytic reaction chamber is preferably constructed of titanium or stainless steel. The catalytic reaction chamber is filled with high purity ceramic pellets of a nonreactive material coated with a catalyst, such a noble metal catalyst. Screens at each end of the reaction chamber prevent the catalyst pellets from being transported outside reaction chamber. The interior of the reaction chamber has two perpendicular baffle plates traversing the length to increase contact area with the catalytic pellets for electrical charge and thermal transport during the reaction. The temperature of the reaction chamber is maintained below 350 C. during operation.

### CROSS REFERENCE TO OTHER APPLICATIONS

This application claims the benefit of U.S. Provisional Application, serial No. 60/311,887, filed on Aug. 13, 2001, the disclosure of which is hereby incorporated by reference.

### FIELD OF THE INVENTION

The present invention relates to a catalytic reactor apparatus and a method for producing high purity water vapor by reacting hydrogen and oxygen.

### BACKGROUND OF THE INVENTION

High purity water vapor with very low impurity levels is required in a variety of industrial and scientific applications. For example, in the production of semiconductors, high purity water vapor is used in the silicon oxide film coating step by the moisture oxidation method. High purity water vapor for this process step can be produced by reacting purified hydrogen and oxygen together in the presence of a catalyst to form high purity water. The catalyst reduces the temperature needed to sustain the reaction, thus improving the safety and controllability of the reaction step. U.S. Pat. Nos. 6,093,662 and 6,180,067, granted to Ohmi et al., describe a method and a reactor for generating water by reacting hydrogen and oxygen within a reaction chamber having an interior coating of platinum to act as a catalyst. While these previous patents represent a significant advance in this technical area, continued research has been directed toward further improvements of such a process, in particular toward the goals of improved safety, reliability and control of the process and improved purity of the water vapor produced.

### SUMMARY OF THE INVENTION

In keeping with the foregoing discussion, the present invention takes the form of a catalytic reactor apparatus and a method for producing high purity water vapor by reacting hydrogen and oxygen together within a catalytic reaction chamber. The reactants and an inert gas, such as argon gas or nitrogen, are supplied to the catalytic reaction chamber in a controlled fashion by a gas panel. The cylindrical catalytic reaction chamber is preferably constructed of titanium or stainless steel. The catalytic reaction chamber is filled with high purity pellets of a nonreactive material coated with a catalyst, such a noble metal catalyst. Screens at each end of the reaction chamber prevent the catalyst pellets from being transported outside reaction chamber. The interior of the reaction chamber has two perpendicular baffle plates traversing the length to increase contact area with the catalytic pellets for electrical charge and thermal transport during the reaction. The temperature of the reaction chamber is maintained below 350 C. during operation.

The catalytic reactor apparatus of the present invention has a number of distinct advantages over the prior art. In particular, the catalytic reactor apparatus has a lower thermal budget in that it does not require heating to initiate or sustain the reaction. The catalytic reactor apparatus allows the reaction temperature to be more precisely controlled for improved safety and reliability. Prior art water vapor generators generally operate at a temperature of approximately 460 C., whereas the operating temperature of the catalytic reactor apparatus of the present invention can be reliably maintained at less than 350 C. Furthermore, the catalytic reactor apparatus of the present invention. The configuration of the catalytic reactor apparatus provides improved flexibility of gas flows to allow adjustability of the flow rate and the concentration of water vapor, hydrogen, oxygen and inert gas in the output of the reactor. The configuration also allows the ability to easily change and recharge the catalyst in the reactor. Additional advantages of the invention include more reliable operation, lower cost of manufacturing and smaller footprint of the reactor compared with prior moisture generator systems.

### BRIEF DESCRIPTION OF THE DRAWINGS

FIG. 1 shows a simplified schematic diagram of a catalytic reactor apparatus according to the present invention for producing high purity water by reacting hydrogen and oxygen.

FIG. 2 shows a right-front perspective view of a preferred embodiment of a catalytic reactor apparatus according to the present invention.

FIG. 3 shows a left-rear perspective view of the catalytic reactor apparatus.

FIG. 4 shows a right-rear perspective view of the catalytic reactor apparatus with the front panel, the back panel and the two top panels of the enclosure removed.

FIG. 5 shows a left-front perspective view of the catalytic reactor apparatus with the enclosure removed.

FIG. 6 shows a right-front perspective view of the catalytic reactor apparatus with the enclosure removed.

FIG. 7 shows a left-rear perspective view of the catalytic reactor apparatus with the enclosure removed.

FIG. 8A shows a cutaway view showing the interior of the catalytic reaction chamber.

FIG. 8B is lateral cross section of the catalytic reaction chamber.

FIG. 9 shows a left-rear perspective view of a catalytic reactor apparatus with multiple catalytic reaction chamber modules.

### DETAILED DESCRIPTION OF THE INVENTION

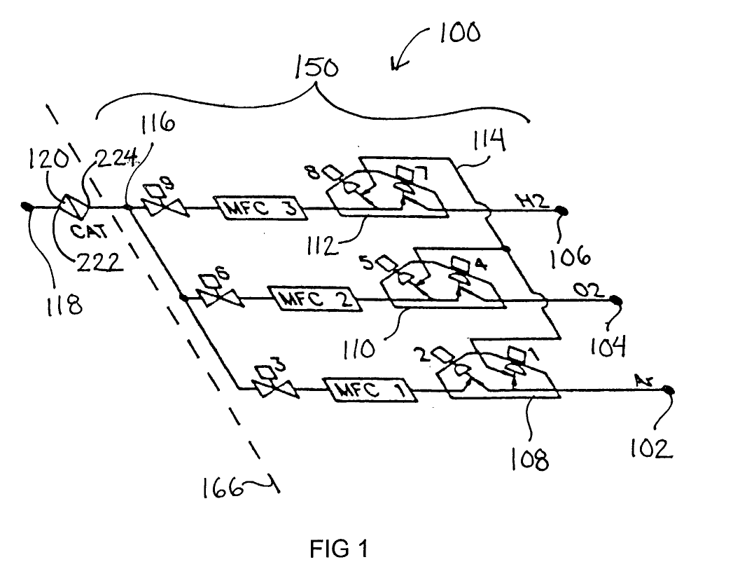

FIG. 1 shows a simplified schematic diagram of a catalytic reactor apparatus 100 according to the present invention for producing high purity water by reacting hydrogen and oxygen together within a catalytic reaction chamber 120. The reactants are supplied to the catalytic reaction chamber 120 in a controlled fashion by a gas panel 150. The gas panel 150 has an Ar gas connection 102 for connecting to a source of inert gas, such as argon gas or, alternatively, nitrogen gas; an O₂ gas connection 104 for connecting to a source of oxygen gas; and an H₂ gas connection 106 for connecting to a source of hydrogen gas. In one particularly preferred configuration, the gas sources include large bulk storage tanks of the necessary gases and the gases are piped to the location of the catalytic reactor apparatus 100 as facility gases. Alternatively, the different gas sources may be configured with smaller, more portable gas storage cylinders. Preferably, the O₂ and H₂ gases are provided with a purity level of less than 100 ppb moisture and total hydrocarbons and the Ar gas is provided with a purity level of less than or equal to 100 ppb moisture and total hydrocarbons.

The Ar gas connection 102 is connected to an Ar purge valve assembly 108, which is used for purging the lines for the reactive gases with Ar gas. Within the Ar purge valve assembly 108, the Ar gas line branches off to a first solenoid operated valve 1 that is configured to deliver Ar gas to the O₂ and H₂ branches of the gas panel 150 via Ar line 114 and to a second solenoid operated valve 2 that is configured to deliver Ar gas through a first mass flow controller MFC 1 to a third solenoid operated valve, the Ar control valve 3.

The O₂ gas connection 104 is connected to an O₂ valve assembly 110. The O₂ gas enters the O₂ valve assembly 110 through a fourth solenoid operated valve 4. A first branch of the Ar line 114 from the Ar purge valve assembly 108 enters the O₂ valve assembly 110 through a fifth solenoid operated valve 5 just downstream of the fourth solenoid operated valve 4. The fourth and fifth solenoid operated valves 4, 5 can be operated to allow the O₂ valve assembly 110 to deliver O₂ or Ar gas through a second mass flow controller MFC 2 to a sixth solenoid operated valve, the O₂ control valve 6. The Ar gas is typically used to purge the O₂ valve assembly 110, the O₂ control valve 6 and the O₂ gas lines.

The H₂ gas connection 106 is connected to an H₂ valve assembly 112. The H₂ gas enters the H₂ valve assembly 112 through a seventh solenoid operated valve 7. A second branch of the Ar line 114 from the Ar purge valve assembly 108 enters the H₂ valve assembly 112 through an eighth solenoid operated valve 8 just downstream of the seventh solenoid operated valve 7. The seventh and eighth solenoid operated valves 7, 8 can be operated to allow the H₂ valve assembly 112 to deliver H₂ and/or Ar gas through a third mass flow controller MFC 3 to a ninth solenoid operated valve, the H₂ control valve 9. The H₂ valve assembly 112 can deliver H₂ and Ar gas mixed in different ratios. The hydrogen concentration can range from 0% to 100%, with concentrations of 1% to 50% being typical for many applications. This gas mixture is the feed reactant gas used in the catalytic reaction chamber 120. The Ar gas can be used separately to purge the H₂ valve assembly 112, the H₂ control valve 9 and the H₂ gas lines.

The outlet of the Ar control valve 3, the O₂ control valve 6 and the H₂ control valve 9 are all connected to a common line 116, which is in turn connected to the inlet 224 of the catalytic reaction chamber 120. A water vapor outlet tube 118 is connected to the outlet 222 at the opposite end of the catalytic reaction chamber 120. The water vapor outlet tube 118 has a titanium connection and, optionally, includes a hydrogen sensor to detect unreacted hydrogen gas.

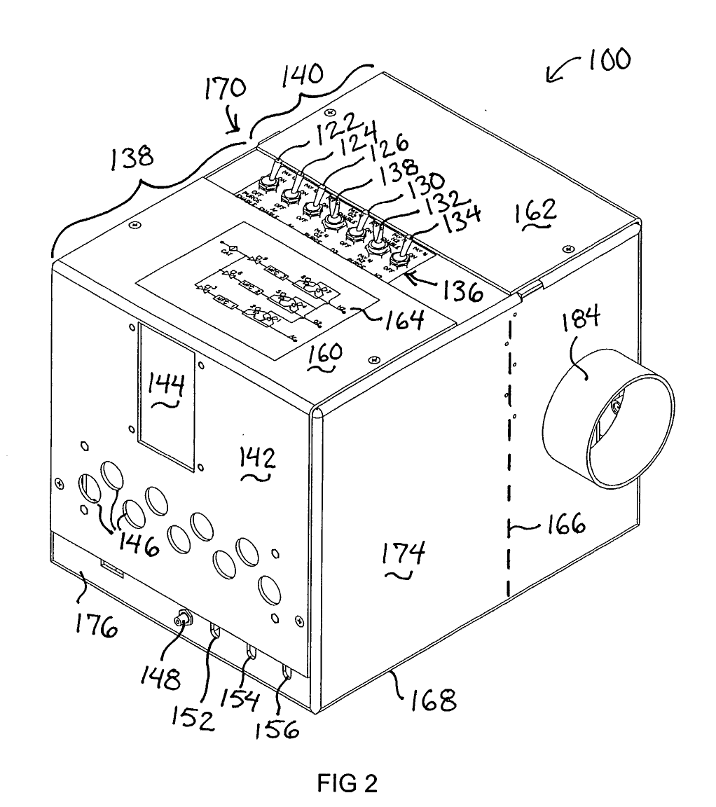

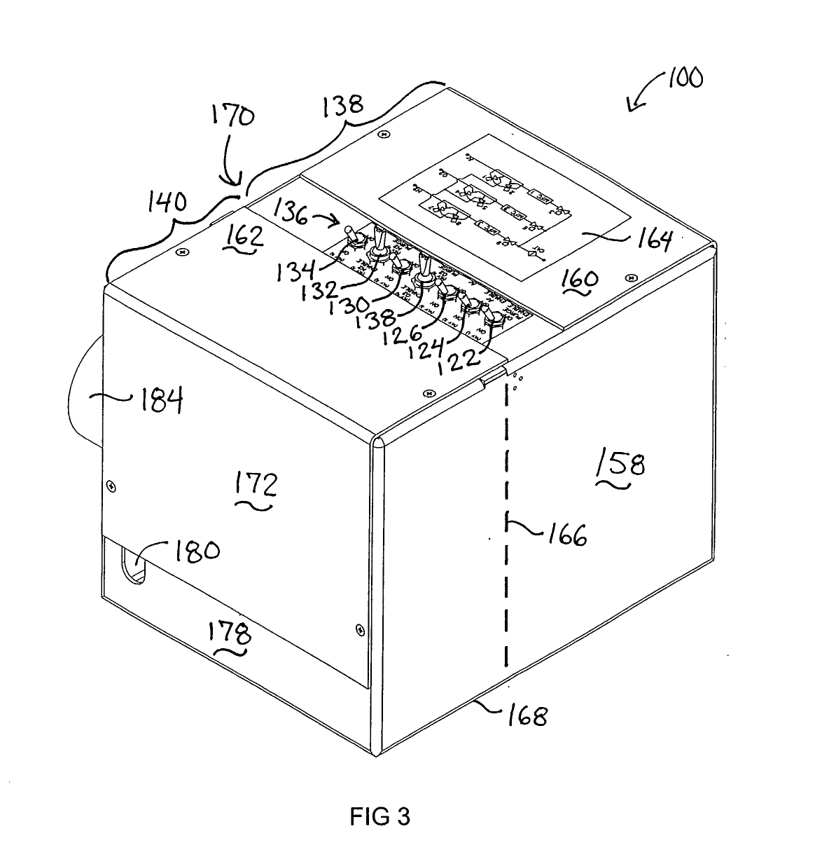

FIGS. 2 and 3 show exterior views of a preferred embodiment of a catalytic reactor apparatus 100 according to the present invention. FIG. 2 shows a right-front perspective view and FIG. 3 shows a left-rear perspective view of the catalytic reactor apparatus 100. The catalytic reactor apparatus 100 is housed within an enclosure 170. The enclosure 170 is divided internally by an isolation panel 166 into a gas panel enclosure 138, housing the components of the gas panel 150, and a reaction chamber enclosure 140, housing the catalytic reaction chamber 120.

The gas panel enclosure 138 has a removable front panel 142 and top panel 160. The front panel 142 is made with one or more cooling air inlets 146 and an access panel 144. For the convenience of the operator, a schematic diagram 164, similar to that shown in FIG. 1, is located on the top panel 160. The reaction chamber enclosure 140 has a removable back panel 172 and top panel 162. In a particularly preferred embodiment of the catalytic reactor apparatus 100, the front panel 142, the back panel 172 and the two top panels 160, 162 of the enclosure 170 are equipped with safety interlock switches that shut down the reactor if any one of the panels is removed.

On the top of the enclosure 170 between the top panel 160 of the gas panel enclosure 138 and the top panel 162 of the reaction chamber enclosure 140 is a control panel 136 where the operating controls of the catalytic reactor apparatus 100 are located. The operating controls located on the control panel 136 include a purge enable switch 122, an Ar enable switch 124, an Ar on/off switch 126, an O₂ enable/purge switch 128, an O₂ on/off switch 130, an H₂ enable/purge switch 132 and an H₂ on/off switch 134.

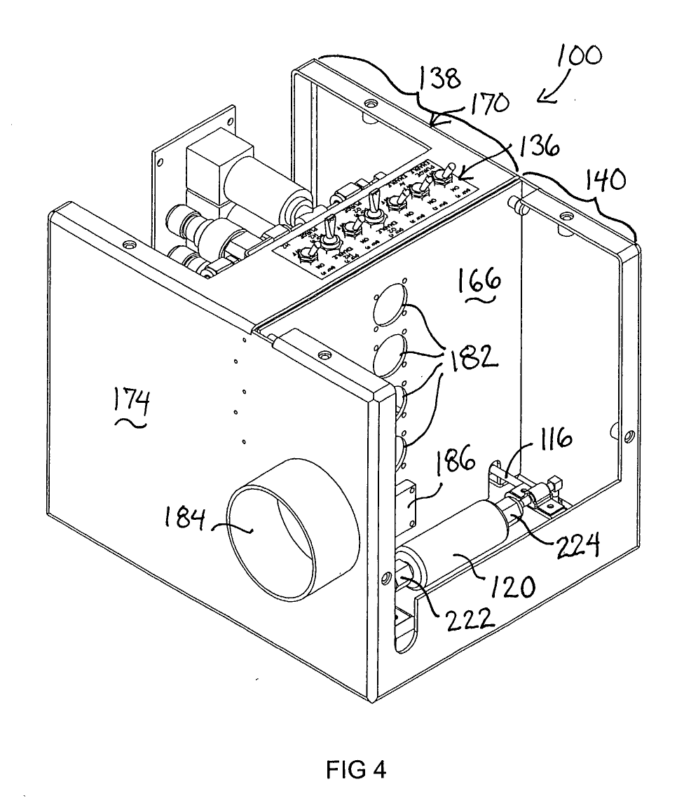

FIG. 4 shows the catalytic reactor apparatus 100 with the front panel 142, the back panel 172 and the two top panels 160, 162 of the enclosure 170 removed to show the interior of the apparatus. FIG. 4 is a right-rear perspective view looking into the reaction chamber enclosure 140. The remainder of the enclosure 170 is made up of the bottom panel 168, the left side panel 158, the right side panel 174, the lower front panel 176, the lower back panel 178 and the control panel 136. The lower front panel 176 has access holes or slots 152, 154, 156 for gas lines to pass through for connection to the Ar gas connection 102, the O₂ gas connection 104 and the H₂ gas connection 106, respectively. An electrical ground connection 148 is connected to the enclosure 170. The lower back panel 178 has an access hole or slot 180 for a water vapor line to pass through for connection to the water vapor outlet tube 118. The access slot 180 is large enough to accommodate insulation and/or a heater 226 surrounding the water vapor outlet tube 118 to prevent condensation of water vapor within the line. A cooling air exhaust duct 184 on the right side panel 174 connects with the interior of the reaction chamber enclosure 140.

The isolation panel 166, which separates the gas panel enclosure 138 and the reaction chamber enclosure 140, can be seen on the interior of the enclosure 170. The isolation panel 166 has one or more internal vents 182 to allow circulation of cooling air from the gas panel enclosure 138 to the reaction chamber enclosure 140. Preferably, one or more cooling fans 186 direct cooling air through the internal vents 182 toward the catalytic reaction chamber 120.

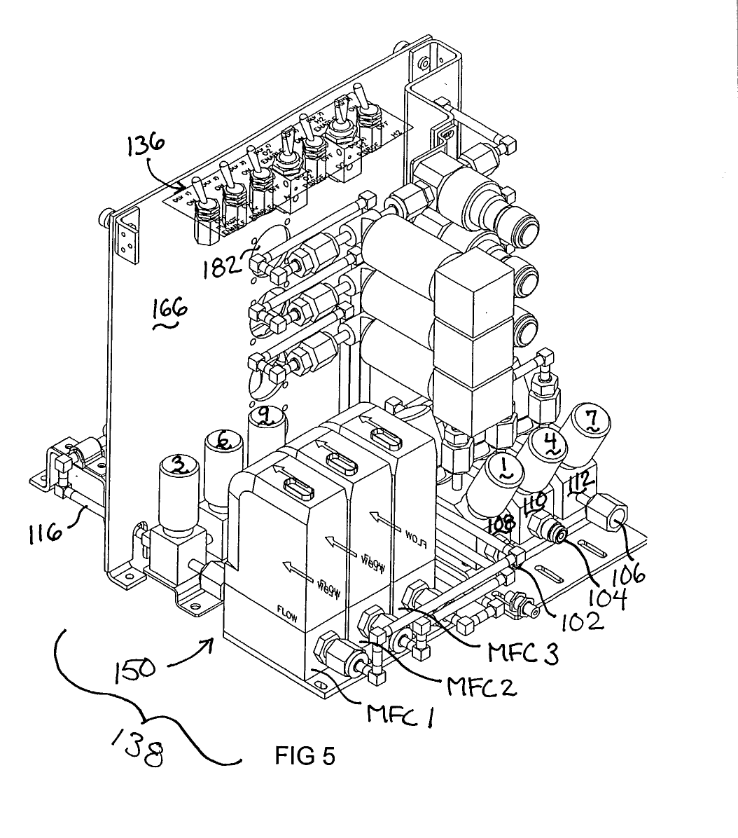

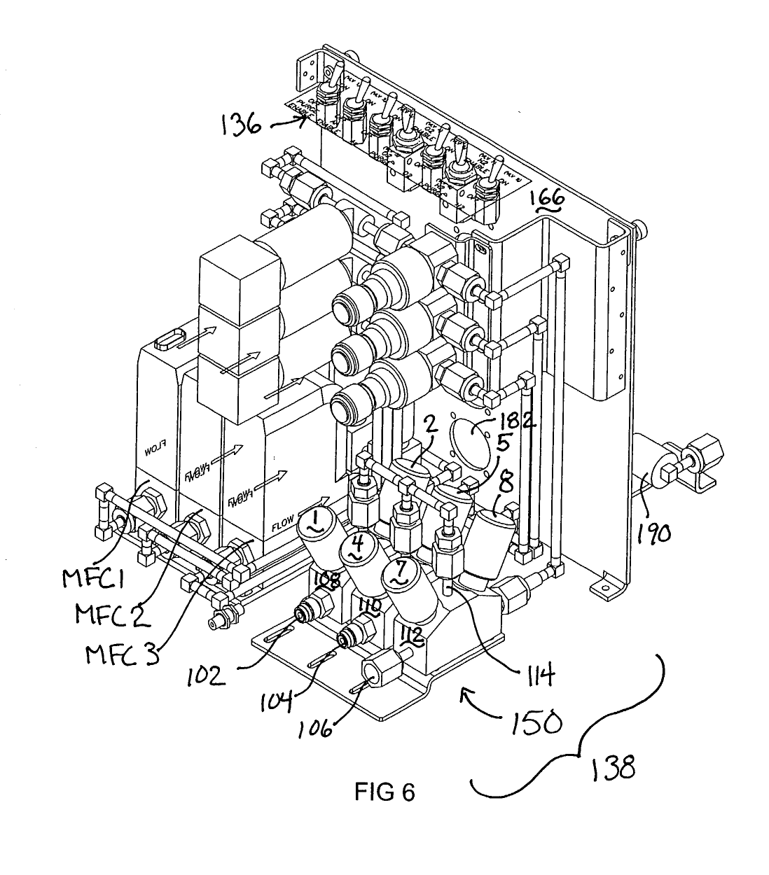

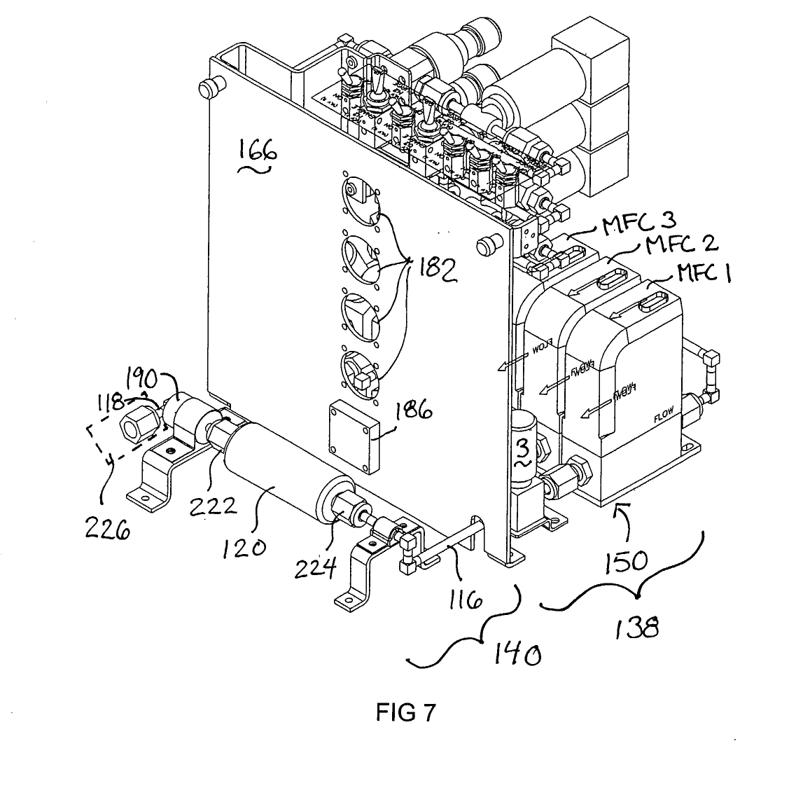

FIGS. 5-7 show the catalytic reactor apparatus 100 with the entire enclosure 170 removed to show the physical layout of the gas panel 150 and the catalytic reaction chamber 120, which are shown schematically in FIG. 1. FIG. 5 is a left-front perspective view and FIG. 6 is a right-front perspective view showing the gas panel 150 within the gas panel enclosure 138. FIG. 7 is a left-rear perspective view showing the catalytic reaction chamber 120 within the reaction chamber enclosure 140.

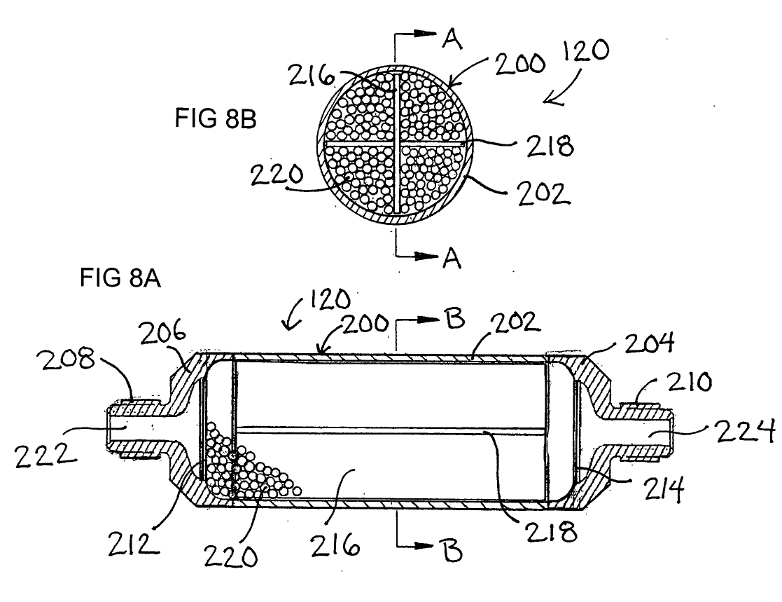

FIG. 8A is a cutaway view of the catalytic reaction chamber 120 with the reactor vessel 200 cut away along line A-A in FIG. 8B to show the interior of the catalytic reaction chamber 120. FIG. 8B is a lateral cross section of the catalytic reaction chamber 120 taken along line B-B in FIG. 8A. The catalytic reaction chamber 120 comprises a generally cylindrical reactor vessel 200 filled with catalyst pellets 220. (The catalytic reaction chamber 120 is shown only partially filled with catalyst pellets 220 in FIG. 8A so that the internal structure of the reactor vessel 200 can be seen.) The catalyst pellets 220 are preferably high purity pellets of a nonreactive material coated with a catalyst. For example, the pellets may be made of a high purity ceramic, such as high purity alumina, and coated with a noble metal catalyst, such as platinum, palladium or iridium. The reactor vessel 200 is constructed of a cylindrical body 202 that is welded to a pair of end caps 204, 206 with gasket-seal VCR fittings 210, 208 or the like machined on them that form the inlet 224 and the outlet 222 of the catalytic reaction chamber 120. The reactor vessel 200 is preferably made of titanium, more preferably grade Ti-CPaR2 titanium, to prevent corrosion and for easy welding. Alternatively, the reactor vessel 200 may be made of stainless steel with an oxide coating having a high percentage of chromium oxide on the reactor vessel 200 and any welds to prevent corrosion and reduce outgassing of impurities. The internal volume of the cylindrical body 202 has two perpendicular baffle plates 216, 218 traversing the length. The baffle plates 216, 218 may be tack welded to the cylindrical body 202. The baffle plates 216, 218 are preferably made of titanium or, alternatively, stainless steel with an oxide coating having a high percentage of chromium oxide. The purpose of these baffle plates 216, 218 is to increase contact area surfaces between the catalyst pellets 220 and the metallic structure of the reactor vessel 200 for electrical charge transport during the reaction. The baffle plates 216, 218 also help to transfer heat out of the reactor vessel 200 to maintain thermal equilibrium during the reaction. Within the end caps 204, 206 at both ends of the cylindrical body 202 are screens or meshes 212, 214 with a pore size of 2-10 μm, which are tack welded to the end caps 204, 206. The screens 212, 214 are preferably made of titanium or, alternatively, stainless steel with an oxide coating having a high percentage of chromium oxide. The interior of the reactor vessel 200 between the screens 212, 214 is filled with catalyst pellets 220. The screens 212, 214 prevent the catalyst pellets 220 from being transported outside the reactor vessel 200 at both ends.

The gas lines upstream of the catalytic reaction chamber 120 are preferably constructed of stainless steel tubing, typically ¼ inch diameter, with 5-10 Ra surface roughness. Optionally, the water vapor outlet tube 118 downstream of the catalytic reaction chamber 120 may be made of titanium and optionally may be welded to the reactor vessel 200.

The purity of the materials used in the reactor are such that the analysis of the steam produced shows extremely low or no metallic impurities. TRXRE analysis data show the levels of Fe, Ni, Cr and other metals in the steam generated by this reactor to be acceptable for stringent semiconductor manufacturing requirements.

To begin operation, the purge enable switch 122 is turned on, which activates solenoid operated valve 1 to supply Ar gas to the O₂ valve assembly 110 and the H₂ valve assembly 112. The Ar enable switch 124 is turned on to open solenoid operated valve 2 and the O₂ enable/purge switch 128 and the H₂ enable/purge switch 132 are moved from the neutral position to the purge position to open solenoid operated valves 5 and 8. Then, the Ar on/off switch 126, the O₂ on/off switch 130 and the H₂ on/off switch 134 are turned on to open solenoid operated valves 3, 6 and 9 to purge the system with Ar gas, typically for a period of approximately 1-5 minutes, to flush out impurities in the system.

After the system has been sufficiently purged with Ar, the Ar is shut off. The reaction is initiated by moving the O₂ enable/purge switch 128 from the purge position to the ON position to close solenoid operated valve 5 and open solenoid operated valve 4. Next, the H₂ enable/purge switch 132 is moved from the purge position to the ON position to close solenoid operated valve 8 and open solenoid operated valve 7. The O₂ and the H₂/Ar mixture flow into the catalytic reaction chamber 120. The H₂ and O₂ contact the catalyst and react to form water vapor at a temperature below the autoignition temperature of 560 C. In many applications, it is preferred to have the H₂ and O₂ in an approximately stoichiometric ratio of 2:1 or with the O₂ slightly in excess of stoichiometric with the H₂ in order to assure complete reaction of the hydrogen. For example, the H₂:O₂ ratio may be in the range of approximately 2:1.1 to 2:1.2, most preferably approximately 2:1.15. In some applications, it is preferable to have the O₂ in excess of stoichiometric with the H₂, to provide oxygen rich water vapor for processes requiring an oxidizing atmosphere. For these applications, the H₂:O₂ ratio can range as low as 2:1.45 or even lower. In other applications, it is preferable to have the H₂ in excess of stoichiometric with the O₂ to provide hydrogen rich water vapor for processes requiring a reducing atmosphere. For these applications, the H₂:O₂ ratio can range as high as 2.9:1 or even higher. The O₂:H₂ ratio can be adjusted using the O₂ and H₂ mass flow controllers MFC 2, MFC 3.

The Ar on/off switch 126 may be turned off or it may remain on depending on the ratio of water vapor to inert gas that is desired for the output of the reactor. The H₂O to Ar ratio can be adjusted from approximately 1 to 100% by adjusting the H₂ to Ar ratio in the feed gas.

Water vapor, or water vapor mixed with Ar gas, flows out of the water vapor outlet tube 118. A filter 190 connected to the water vapor outlet tube 118 removes impurities from the water vapor produced. Particles in excess of approximately 0.0003 μm size are filtered out.

As the exothermic reaction proceeds, there is a temperature rise. Air flow cooling is employed using fans 186 that work to lower the skin temperature of the catalytic reaction chamber 120. The temperature increases at a predetermined rate and the temperature sensor feedback loop is used to detect anomalies and warn the user appropriately. If the temperature sensor senses a temperature greater than 350 C., the reaction is automatically shut off by shutting down the H₂ flow and/or the mixed gas flow in the common line 116. One or more thermal fuses may be placed at various points in the control circuit as a safety shutdown in case the catalytic reaction chamber 120 exceeds the maximum allowable temperature. Alternatively, if the temperature sensor senses a temperature less than 50 C. after 2 minutes, the same automatic shutdown sequence occurs to check the catalytic reactor apparatus 100 for malfunction.

To shut the catalytic reactor apparatus 100 down after use, the H₂ is shut off first, then the Ar is shut off and finally the catalytic reaction chamber 120 is purged with O₂, which is then shut off.

The catalytic reactor apparatus 100, in the configuration shown, is capable of delivering from approximately 100 sccm (standard cubic centimeters per minute) to 1 slm (standard liters per minute) of high purity water vapor. The catalytic reactor apparatus 100 is also scalable to deliver any desired rate of high purity water vapor. In a preferred method, the capacity of the catalytic reactor apparatus 100 can be increased in a modular fashion by connecting multiple catalytic reaction chambers 120 in parallel, with each catalytic reaction chamber 120 providing up to 1 slm of high purity water vapor. This modular approach is advantageous because the thermal characteristics of the catalytic reaction chambers 120 are already known and would not need to be reengineered for safety and thermal equilibrium.

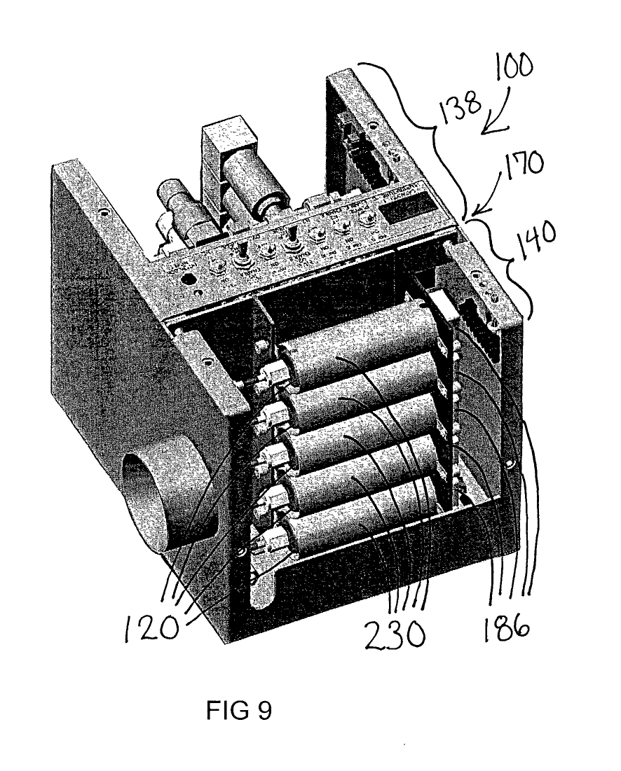

FIG. 9 shows a left-rear perspective view of a catalytic reactor apparatus 100 with multiple catalytic reaction chamber modules 120 connected in parallel within the reaction chamber enclosure 140. In this exemplary embodiment, five catalytic reaction chamber modules 120 are connected in parallel within the reaction chamber enclosure 140. As many as fifteen catalytic reaction chamber modules 120 can be arranged within the current dimensions of the reaction chamber enclosure 140. If greater capacity is needed, the reaction chamber enclosure 140 can simply be expanded to accommodate more catalytic reaction chamber modules 120. In this exemplary embodiment, each of the catalytic reaction chamber modules 120 is surrounded by a cooling air duct 230, each of which is provided with cooling air by a separate cooling fan 186. The cooling air ducts 230 may be generally cylindrical with the cooling fans 186 oriented axially with respect to the cylinder, as shown, or any other convenient geometry for directing the flow of cooling air over the surface of the catalytic reaction chamber modules 120.

While the present invention has been described herein with respect to the exemplary embodiments and the best mode for practicing the invention, it will be apparent to one of ordinary skill in the art that many modifications, improvements and subcombinations of the various embodiments, adaptations and variations can be made to the invention without departing from the spirit and scope thereof.

What is claimed is:

1. Apparatus for producing high purity water vapor, the apparatus comprising:
a source of hydrogen;
a source of oxygen;
a source of inert gas;
a reaction chamber containing a multiplicity of pellets coated with a catalyst;
means for metering the hydrogen, oxygen and inert gas into the reaction chamber with an approximately stoichiometric ratio of hydrogen to oxygen to produce water vapor at a reaction temperature below the autoignition point without undergoing combustion at high temperature; and
an outlet for conducting water vapor away from the reaction chamber.

2. The apparatus of claim 1, further comprising:
a filter connected to the outlet.

3. The apparatus of claim 1, further comprising:
a heater for preventing condensation of water in the outlet.

4. The apparatus of claim 1, further comprising:
a safety isolation panel separating the source of hydrogen and the source of oxygen from the reaction chamber.

5. The apparatus of claim 4, further comprising:
an enclosure enclosing at least the reaction chamber.

6. The apparatus of claim 5, further comprising:
an exhaust fan for venting the interior of the enclosure.

7. The apparatus of claim 5, further comprising:
a safety interlock configured to shut off gas flow into the reaction chamber if the enclosure is opened.

8. The apparatus of claim 1, further comprising:
a source of high purity inert gas and means for feeding the high purity inert gas into the reaction chamber prior to metering the hydrogen and oxygen into the reaction chamber.

9. The apparatus of claim 8, further comprising:
means for feeding the high purity inert gas into the reaction chamber after ceasing metering the hydrogen and oxygen into the reaction chamber.

10. The apparatus of claim 1, wherein the reaction chamber is made of titanium.

11. The apparatus of claim 1, wherein the reaction chamber is made of stainless steel with an oxide coating layer with a high percentage of chromium oxide.

12. The apparatus of claim 1, wherein the catalyst comprises palladium.

13. The apparatus of claim 1, wherein the catalyst comprises platinum.

14. The apparatus of claim 1, wherein the catalyst is coated on the surface of a multiplicity of high purity ceramic pellets within the reaction chamber.

15. The apparatus of claim 14, wherein the pellets comprise high purity alumina.

16. The apparatus of claim 1, further comprising:
a temperature sensor for measuring the temperature within the reaction chamber.

17. The apparatus of claim 16, further comprising:
a temperature feedback loop for limiting the temperature within the reaction chamber.

18. The apparatus of claim 17, wherein the temperature feedback loop is configured to reduce the flow of the hydrogen into the reaction chamber when the temperature within the reaction chamber exceeds a preset limit.

19. The apparatus of claim 1, further comprising:
a cooling system for cooling the reaction chamber.

20. The apparatus of claim 19, wherein the cooling system comprises a cooling fan for blowing cooling air across the reaction chamber.

21. The apparatus of claim 1, further comprising means for mixing the hydrogen and inert gas prior to metering the hydrogen and inert gas into the reaction chamber.

22. The apparatus of claim 1, wherein the hydrogen and oxygen are metered into the reaction chamber at a ratio of approximately 2:1 hydrogen to oxygen.

23. The apparatus of claim 1, wherein the hydrogen and oxygen are metered into the reaction chamber at a ratio of approximately 2:1.1 hydrogen to oxygen.

24. The apparatus of claim 1, wherein the hydrogen and oxygen are metered into the reaction chamber at a ratio of approximately 2:1.15 hydrogen to oxygen.

25. The apparatus of claim 1, wherein the hydrogen and oxygen are metered into the reaction chamber at a ratio of approximately 2:1.2 hydrogen to oxygen.

26. A method for producing high purity water vapor, the method comprising:
metering hydrogen and oxygen gas into a reaction chamber containing a multiplicity of pellets coated with a catalyst at an approximately stoichiometric ratio of hydrogen to oxygen to produce water vapor at a reaction temperature below the autoignition point without undergoing combustion at high temperature.

27. The method of claim 26, further comprising mixing the hydrogen with an inert gas prior to metering the hydrogen and inert gas into the reaction chamber.

28. The method of claim 26, further comprising:
feeding high purity inert gas into the reaction chamber prior to metering the hydrogen and oxygen gas into the reaction chamber.

29. The method of claim 26, further comprising:
feeding high purity inert gas into the reaction chamber after ceasing metering the hydrogen and oxygen gas into the reaction chamber.

30. The method of claim 26, wherein the hydrogen and oxygen are metered into the reaction chamber at a ratio of approximately 2:1 hydrogen to oxygen.

31. The method of claim 26, wherein the hydrogen and oxygen are metered into the reaction chamber at a ratio of approximately 2:1.1 hydrogen to oxygen.

32. The method of claim 26, wherein the hydrogen and oxygen are metered into the reaction chamber at a ratio of approximately 2:1.2 hydrogen to oxygen.
